(19) United States
(12) Patent Application Publication
(10) Pub. No.: US 2022/0037725 A1
(43) Pub. Date: Feb. 3, 2022

(54) BATTERY PACK FOR A HAND-HELD POWER TOOL

(71) Applicant: Hilti Aktiengesellschaft, Schaan (LI)

(72) Inventor: Robert STANGER, Kaufbeuren (DE)

(21) Appl. No.: 16/762,727

(22) PCT Filed: Nov. 19, 2018
(86) PCT No.: PCT/EP2018/081717

§ 371 Date: Sep. 10, 2021

(30) Foreign Application Priority Data
Dec. 18, 2017 (EP) 17207924.6

(51) Int. Cl. H01M 50/211; H01M 50/247; H01M 50/291; H01M 50/293; H01M 10/052

(52) U.S. Cl. CPC H01M 50/211; H01M 50/247; H01M 2220/30; H01M 50/293; H01M 10/052; H01M 50/291

(57) ABSTRACT

A battery pack for an electric hand-held power tool, the battery pack having a housing with at least two pouch cells arranged therein, a filling material being located between the pouch cells, wherein the filling material is reversibly-elastically deformable in such a way that the filling material can yield to an increase in volume of the pouch cells.

The present invention relates to a battery pack for an electric hand-held power tool, the battery pack having a housing with at least two pouch cells arranged therein, a filling material being located between the pouch cells.

### BACKGROUND

DE 10 2013 111 500 A1 discloses a rechargeable battery for use in electric vehicles, the rechargeable battery having a plurality of battery cells, of which each individual battery cell is cast under prestress in a resin-hardener mixture and to avoid volume work by the battery cells.

### SUMMARY OF THE INVENTION

It is an object of the present invention to provide a battery pack in which damage, in particular to the housing, is avoided, or at least reduced.

The present invention provides a filling material being reversibly-elastically deformable in such a way that the filling material can yield to an increase in volume of the pouch cells.

The invention includes the finding that, in the case of battery packs of the prior art, the battery cells are cast under prestress in a resin-hardener mixture. It has been observed that the when there is an increase in volume of the battery cells—known as swelling—can lead to mechanical stresses and forces that are at least partially transferred to the housing of the battery pack. In particularly extreme cases, the battery cells themselves, but also the housing of the battery pack, can be damaged. The so-called swelling has hitherto been unavoidable and, in particular in the case of pouch cells, occurs due to the pouch-cell-specific aging of the cells.

The fact that, according to the invention, the filling material is reversibly-elastically deformable means that the filling material can thus yield to an increase in volume of the pouch cells. In other words, when there is an increase in volume of the pouch cells, this additional volume can be compensated by the filling material. This prevents mechanical stresses from occurring and the housing of the battery pack from being damaged or even broken open. A reduction in the volume of the pouch cells, for example caused by a drop in the ambient temperature, can also be compensated by the reversibly-elastic filling material. Firstly, voids can be avoided between the pouch cells and the filling material. Furthermore, the reversibly-elastically deformable filling material provides cell protection against external mechanical influences.

It has proven to be advantageous if the filling material has a material elasticity that is greater than a cell elasticity of the pouch cells.

In a particularly preferred configuration, the filling material is or comprises an elastomer. The filling material is preferably selected from the group: polyurethane, butadiene rubber, butyl rubber, ethylene-propylene-diene rubber and silicone rubber.

In a particularly preferred configuration, the filling material is provided in the form of at least one insert element which is inserted or is to be inserted between the pouch cells. If a plurality of pouch cells are provided, there is preferably one insert element each between adjacent pouch cells. The insert elements are preferably of a flat form, wherein a surface can be essentially the same size as a surface of a respective pouch cell.

In another preferred configuration, the filling material is provided in the form of a potting compound. The potting compound preferably completely encapsulates the pouch cell and/or the pouch cells. In a further preferred configuration, both the pouch cells are completely encapsulated by the potting compound and the housing is essentially completely filled with the potting compound.

It has proven to be advantageous if the filling material is located between at least one of the pouch cells and a wall of the housing. If the filling material is provided in the form of at least one insert element, this can be arranged between an outer pouch cell and the wall of the housing.

It has proven to be particularly advantageous that each of the pouch cells adjoins the filling material on both sides. The pouch cells are particularly preferably designed as lithium-polymer cells. The filling material is preferably free of a thermosetting plastic.

In a particularly preferred configuration, the no-load voltage of the battery is limited to 60 V DC.

Further advantages will become apparent from the following description of the figures. Various exemplary embodiments of the present invention are shown in the figures. The figures, the description and the claims contain numerous features in combination. A person skilled in the art will expediently also consider the features individually and combine them to produce expedient further combinations.

### BRIEF DESCRIPTION OF THE DRAWINGS

In the figures, identical components and components of identical type are designated by identical reference signs. In the figures:

FIG. 1 shows a first preferred exemplary embodiment of a battery pack according to the invention, the filling material being provided in the form of insert elements;

FIG. 2 shows a perspective view of the exemplary embodiment of FIG. 1;

FIG. 3 shows the exemplary embodiment of FIGS. 1 and 2, the pouch cells undergoing a swelling;

FIG. 4 shows a second preferred exemplary embodiment of a battery pack according to the invention, the filling material being provided in the form of a potting compound;

FIG. 5 shows a perspective representation of the exemplary embodiment of FIG. 4; and

FIG. 6 shows the exemplary embodiment of FIGS. 4 and 5, the pouch cells undergoing a swelling.

### DETAILED DESCRIPTION

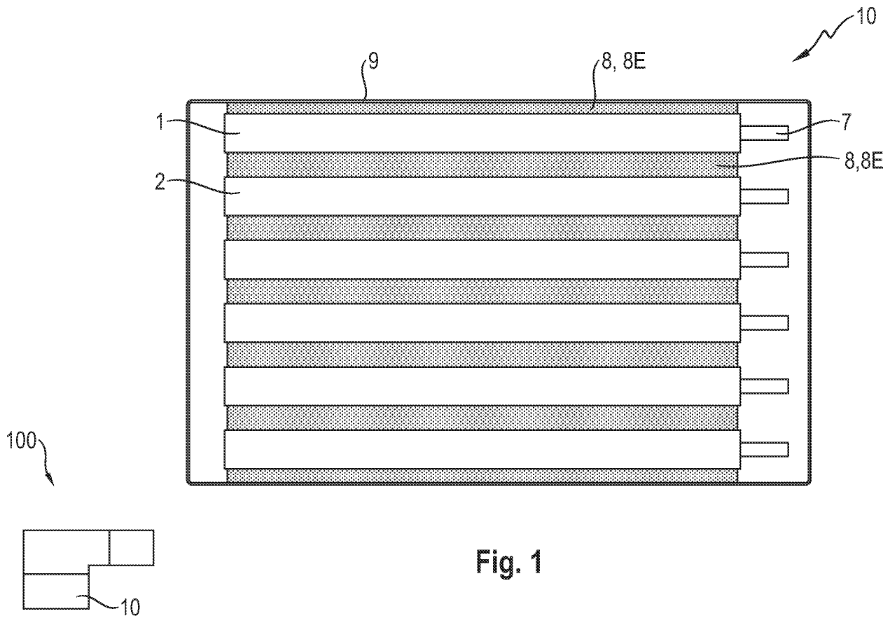

A schematic representation of a particularly preferred exemplary embodiment of a battery pack 10 according to the invention is shown in FIG. 1.

The battery pack 10 serves for supplying electrical power to an electric hand-held power tool 100, which is schematically represented in the left corner of FIG. 1. The battery pack 10 is formed as a removable battery for the electric hand-held power tool 100.

The battery pack 10 has a housing with at least two pouch cells 1, 2 arranged therein. In the exemplary embodiment shown here, six pouch cells are provided.

A filling material 8 is located between the pouch cells 1, 2. In the exemplary embodiment shown in FIG. 1, the filling material 8 is provided as an insert element 8E which is inserted between the pouch cells 1, 2.

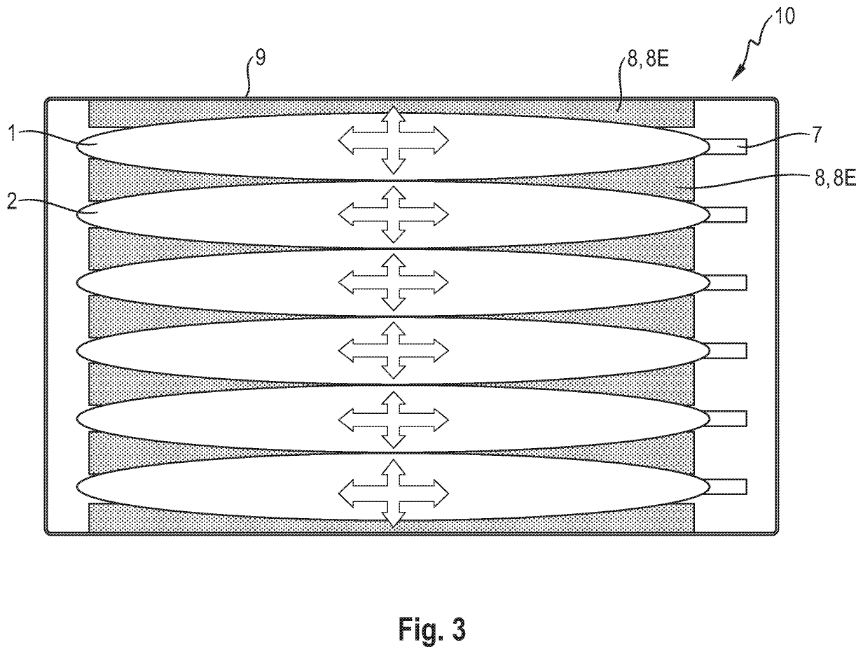

According to the invention, the filling material is provided as a reversibly-elastically deformable filling material, so that the filling material 8 can yield to an increase in volume of the pouch cells 1, 2 (cf. FIG. 3).

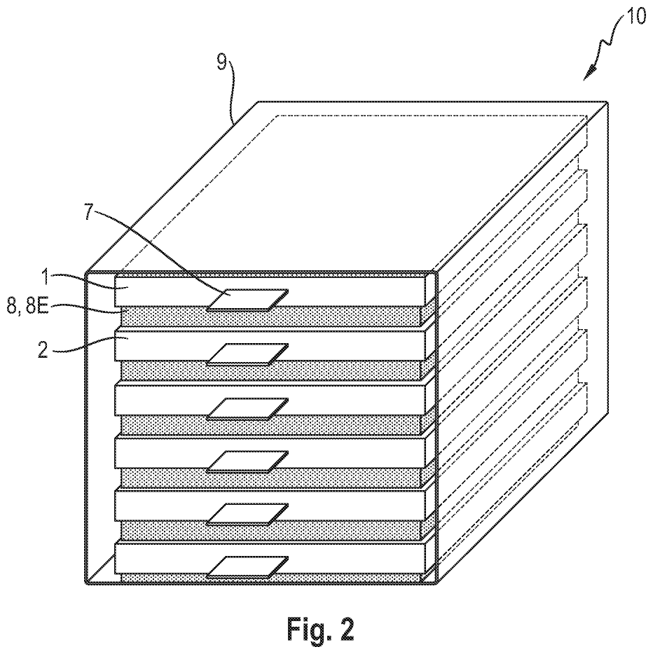

By way of example, the filling material 8 provided in the form of insert elements 8E is provided in the form of flat butadiene rubber mats. The respective insert elements 8E are arranged both between all of the adjacent pouch cells 1, 2 and between the pouch cell 1 and a wall of the housing 9. Each of the pouch cells 1, 2 adjoins the filling material 8 on both sides. On the respective short sides (left and right in FIG. 1), the pouch cells 1, 2 are free of filling material 8. This can be seen particularly well in FIG. 2, which shows a perspective representation of the exemplary embodiment from FIG. 1. It can likewise be seen from FIG. 2 that the longitudinal sides of the respective pouch cells 1, 2 (left and right sides in FIG. 2) are also free of the filling material 8.

In the exemplary embodiment shown, the pouch cells 1, 2 are designed as lithium-polymer cells and are electrically contacted with one another via the contact tabs 7; by way of example, the no-load voltage of the battery pack 10 is limited to 60 V DC.

The advantage according to the invention of the reversibly-elastically deformable filling material 8 can now be seen from FIG. 3. During the so-called swelling of the pouch cells 1, 2, the pouch cells expand on all sides, but especially in their thickness.

This increase in volume of the pouch cells 1, 2 has the effect that the reversibly-elastically deformable filling material 8 deforms, in the specific case is compressed. This compensates for an increase in volume of the pouch cells 1, 2 and avoids, or at least significantly reduces, a mechanical compressive stress on the housing 9 or the pouch cells 1, 2 with respect to one another.

By contrast with battery packs of the prior art, in which a volume work of the battery cells is to be avoided by thermosetting resin-hardener mixtures, it is precisely the concept of the present invention to yield specifically to this volume work of the battery cells in a compensatory manner.

In the present exemplary embodiment, the filling material 8 has a material elasticity that is greater than a cell elasticity of the pouch cells.

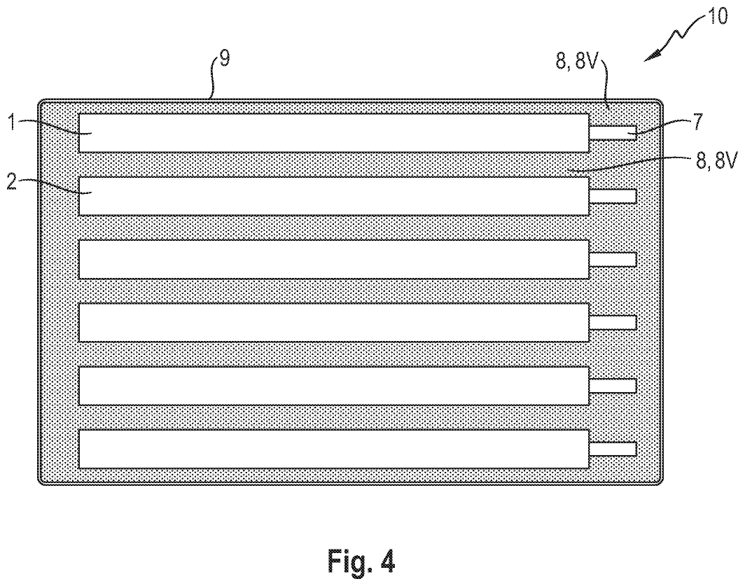

A second preferred exemplary embodiment of a battery pack 10 according to the invention is shown in FIG. 4. This battery pack 10 also has a filling material 8 which is reversibly-elastically deformable in such a way that the filling material 8 can yield to an increase in volume of the pouch cells 1, 2.

By contrast with the exemplary embodiment described with reference to FIGS. 1 to 3, the filling material 8 is provided in the form of a potting compound 8V which completely encapsulates the pouch cells 1, 2. The filling material 8 has a material elasticity that is greater than a cell elasticity of the pouch cells 1, 2. In the present exemplary embodiment, the filling material 8 is provided in the form of an elastomerically formulated polyurethane.

As can be seen in FIG. 4, each of the six pouch cells 1, 2 is completely encapsulated by the filling material 8 in the form of one of the potting compound 8V.

Furthermore, filling material 8 in the form of the potting compound 8V is also present between the outer pouch cells and the wall of the housing 9.

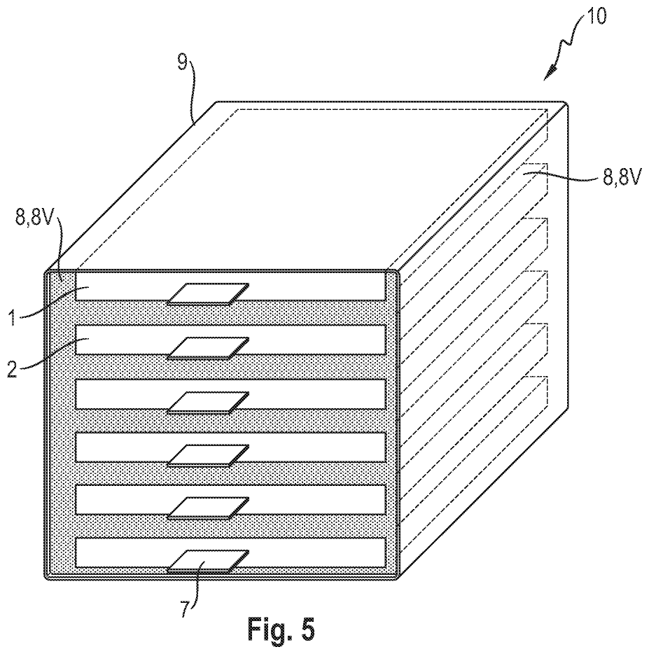

This can be seen particularly well in FIG. 5, which shows the exemplary embodiment of FIG. 4 in a perspective representation. The entire housing 9 is filled with the potting compound 8V, so that there are no voids between the pouch cells 1, 2 with respect to one another and no voids between the pouch cells and the housing 9.

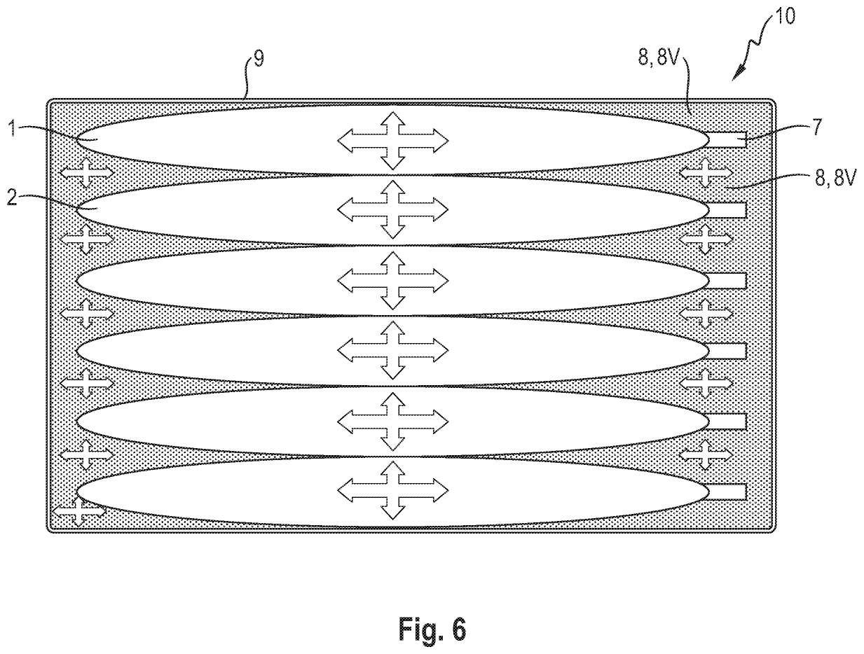

FIG. 6 now shows the exemplary embodiment of FIGS. 4 and 5, wherein the pouch cells 1, 2 have undergone the so-called swelling. The reversibly-elastically deformable configuration of the potting compound 8V allows it to yield to an increase in the volume of the pouch cells 1, 2 shown here.

As can be seen in FIG. 6, the pouch cells 1, 2 expand on all sides, the complete encapsulation by the potting compound 8V also allowing the same to yield on all sides. As a result, the pouch cells 1, 2 are protected against mechanical influences and likewise cannot transmit any significant mechanical stresses to the housing 9 or adjacent pouch cells.

It has been shown that this significantly increases the stability or long-term durability of the battery pack 10, in particular in robust use or when the cells are heated.

### LIST OF REFERENCE SIGNS

1 Pouch cell

2 Pouch cell

7 Contact tab

8 Filling material

8E Insert element

8V Potting compound

9 Housing

10 Battery pack

100 Hand-held power tool

1-10. (canceled)

11. A battery pack for an electric hand-held power tool, the battery pack comprising:
a housing;
at least two pouch cells arranged in the housing: and
a filling material located between the pouch cells, the filling material being reversibly-elastically deformable so that the filling material is yieldable to an increase in volume of the pouch cells.

12. The battery pack as recited in claim 11 wherein the filling material has a material elasticity that is greater than a cell elasticity of the pouch cells.

13. The battery pack as recited in claim 11 wherein the filling material includes an elastomer.

14. The battery pack as recited in claim 13 wherein the elastomer is selected from the group consisting of: polyurethane, butadiene rubber, butyl rubber, ethylene-propylene-diene rubber and silicone rubber.

15. The battery pack as recited in claim 11 wherein the filling material is provided in the form of at least one insert element inserted between the pouch cells.

16. The battery pack as recited in claim 11 wherein the filling material is provided in the form of a potting compound.

17. The battery pack as recited in claim 16 wherein the potting compound completely encapsulates the pouch cells.

18. The battery pack as recited in claim 11 wherein filling material is located between at least one of the pouch cells and a wall of the housing.

19. The battery pack as recited in claim 11 wherein each of the pouch cells adjoins the filling material on both sides.

20. The battery pack as recited in claim 11 wherein the pouch cells are designed as Li-polymer cells.

21. The battery pack as recited in claim 11 wherein the filling material is free of a thermosetting plastic.

22. The battery pack as recited in claim 11 wherein a no-load voltage of the battery pack is limited to a 60 V DC voltage.
